(19) United States
(12) Patent Application Publication
(10) Pub. No.: US 2020/0231016 A1
(43) Pub. Date: Jul. 23, 2020

(54) VARYING APPROACH, DEPARTURE, AND BREAKOVER ANGLES WITH SUSPENSION SYSTEM ACTUATORS

(71) Applicant: ClearMotion, Inc., Billerica, MA (US)

(72) Inventor: Gert-Jan Alexander Vente, North Andover, MA (US)

(73) Assignee: ClearMotion, Inc., Billerica, MA (US)

(21) Appl. No.: 16/749,258

(22) Filed: Jan. 22, 2020

Related U.S. Application Data
(60) Provisional application No. 62/795,807, filed on Jan. 23, 2019.

(51) Int. Cl. B60G 17/0165; G01S 17/931

(52) U.S. Cl. CPC B60G 17/0165; G01S 17/931; B60G 2400/823; B60G 2400/252; B60G 2400/0512

(57) ABSTRACT

Disclosed herein are methods and systems for modifying the posture of a vehicle, while traversing obstacles and/or steep slope transitions of a driving surface by, for example, adjusting approach, departure, and/or breakover angles by using one or more active suspension components.

### CROSS-REFERENCE TO RELATED APPLICATIONS

This application claims the benefit of priority under 35 U.S.C. § 119(e) of U.S. provisional application Ser. No. 62/795,807, filed Jan. 23, 2019, the disclosure of which is incorporated by reference in its entirety.

### FIELD

Embodiments described herein relate to methods and systems for improving control of vehicles.

### BACKGROUND

While travelling over various road and off-road driving surfaces, it is sometimes necessary to traverse sections that include steep gradient changes or other obstructions. Various aspects of a vehicle's geometry may determine if a vehicle may be able to traverse such anomalies without interference between a surface on the vehicle body (e.g., a vehicle chassis or undercarriage) and a segment of the driving surface or obstruction.

### SUMMARY

This disclosure discusses systems and methods for using one or more suspension system actuators to adjust a posture (e.g., a pitch angle) of a vehicle body in response to information about driving surface anomalies (e.g., road transitions, rocks/boulders, driveway exits, etc.) that may interfere with one or more surfaces (e.g., a chassis, bumper) on the vehicle. In some embodiments, a vehicle's active suspension system may allow a ride height at each wheel to be adjusted individually.

According to one aspect, a method of operating a first motor vehicle is disclosed. The method includes, with one or more controllers, receiving information based on data from a first set of one or more sensors. The method also includes, with the one or more controllers, over a first segment of a driving surface, using at least a portion of the information based on data from the first set of one or more sensors to control a first set of one or more actuators to minimize relative motion between a sprung mass of the first motor vehicle and the first segment of the driving surface. The method also includes, with the one or more controllers, receiving information based on data from a second set of one or more sensors. The method also includes with the one or more controllers, over a second segment of the driving surface, using at least a portion of the information based on data from the second set of sensors to control a second set of one or more actuators to modify a vehicle angle selected from the group consisting of an approach angle, a departure angle, and a breakover angle, wherein the first set of actuators and the second set of actuators have at least one actuator in common.

In some embodiments, modifying the vehicle angle comprises increasing a pitch angle in at least one of a positive direction and a negative direction. In some instances, minimizing relative motion between the sprung mass of the first vehicle and the first segment of the driving surface includes using a skyhook control algorithm in at least one of the one or more controllers. In some instances, the first segment of the driving surface is a portion of a road selected from the group consisting of a public city road and a public highway. In some instances, the second segment of the driving surface is a portion of an off-road surface.

In some embodiments, the at least one actuator in common is selected from the group consisting of an active suspension actuator, an adjustable air spring, and an active roll bar.

In some embodiments, the information based on data received from at least one of the first set of one or more sensors and the second set of one or more sensors includes information about the location of the first vehicle relative to the driving surface.

In some embodiments the first set of sensors and the second set of sensors have at least one sensor in common. In some instances, the at least one sensor in common is selected from the group consisting of a LIDAR system, a radar system, and a GPS receiver.

In some embodiments, the method also includes providing, to a second vehicle or a central data storage facility, information about a modification of the vehicle angle and the location where the modification was made.

In some embodiments, modifying the vehicle angle comprises adjusting a ride height of the first vehicle while maintaining a pitch angle of the vehicle.

According to another aspect, a method of operating a motor vehicle that includes at least a first suspension system actuator is disclosed. The method includes obtaining information about a first motion of a sprung mass of the motor vehicle, operating a first controller configured to execute a first control algorithm that generates a first command signal based on the information about the first motion, providing the first command signal to the first suspension system actuator, generating a first force with the first suspension system actuator, and applying the first force to the sprung mass to mitigate the first motion. The method also includes obtaining information about a driving surface to be traversed by the motor vehicle, obtaining information about the geometry of the motor vehicle, and, based at least on the information about the driving surface and the information about the geometry of the motor vehicle, determining that a segment on the driving surface will interfere with a surface on the motor vehicle. The method also includes operating a second controller that includes a second control algorithm configured to execute a second command signal based on the information about the driving surface and the information about the geometry of the motor vehicle, providing the second command signal to the first suspension system actuator, generating a second force with the first suspension system actuator, and applying the second force to the sprung mass to induce a second motion.

In some embodiments, the first motion and the second motion include changes in a pitch angle of the vehicle. In some instances, the first motion occurs during fore-aft acceleration or deceleration of the vehicle, and wherein the second motion is induced to avoid interference between the surface on the vehicle and the segment on the driving surface.

In some embodiments, the first controller and the second controller are the same controller.

According to another aspect, a method of operating a suspension system of a vehicle having one or more front wheels, one or more rear wheels, and a vehicle body, is disclosed. The method includes obtaining information about a terrain ahead of the vehicle, and, based on the obtained information, determining that a slope of the terrain exceeds an approach angle of the vehicle. The method also includes in response to said determination, compressing at least one actuator arranged between a rear wheel and the vehicle body and extending at least one actuator arranged between a front wheel and the vehicle body, thereby increasing a pitch of the vehicle body to increase the approach angle.

According to another aspect, a method of operating a suspension system of a vehicle having one or more front wheels, one or more rear wheels, and a vehicle body is disclosed. In a first operating mode operating mode, at least one controller of an active suspension system may be used mitigate a motion of the vehicle body, such as road induced disturbances, while the vehicle is being driven. In a second operating mode, the at least one controller may be used increase the vehicle approach angle and/or the vehicle departure angle.

### BRIEF DESCRIPTION OF DRAWINGS

The foregoing summary, as well as description of the embodiments will be better understood when read in conjunction with the appended drawings. For the purpose of illustrating one or more embodiments of the present inventions, and to explain their operation, drawings and schematic illustrations are shown. It should be understood, however, that the invention(s) are not limited to the precise arrangements, variants, structures, features, embodiments, aspects, methods, advantages, improvements and instrumentalities shown, and the arrangements, variants, structures, features, embodiments, aspects, methods, advantages, improvements and instrumentalities shown and/or described may be used singularly in the system or method or may be used in combination with other arrangements, variants, structures, features, embodiments, aspects, methods, advantages, improvements and instrumentalities.

The accompanying drawings are not intended to be drawn to scale. In the drawings, each identical or nearly identical component in various embodiments that is illustrated in various figures may be represented by a like numeral. For purposes of clarity, not every component may be labeled in every drawing. In the drawings:

FIG. 1 shows a vehicle approaching an incline in a driving surface, the vehicle being in a first posture and having a first approach angle.

FIG. 2 shows the vehicle of FIG. 1 in the first posture approaching a steeper incline and interference between a bumper of the vehicle and a surface of the steeper incline.

FIG. 3 shows the vehicle of FIG. 1 in a second posture, wherein the second posture has a second approach angle caused by raising a front portion of the vehicle and increasing a pitch angle in a negative direction.

FIG. 4 shows the vehicle of FIG. 1 in a third posture with a third approach angle, where the third approach angle is larger than the first approach angle and the second approach angle (shown in FIGS. 3 and 4, respectively) and is caused by lowering a rear portion of the vehicle to increase the pitch angle in the negative direction.

FIG. 5 shows the vehicle of FIG. 1 in a fourth posture moving away from an incline in a driving surface.

FIG. 6 shows the vehicle of FIG. 1 in a fifth posture caused by raising a rear portion of the vehicle and lowering a front portion of the vehicle to increase a departure angle and a pitch angle in a positive direction.

FIG. 7 shows the vehicle of FIG. 1 in a sixth posture traversing a discontinuity in a gradient of a driving surface where the front wheels and rear wheels are on opposite sides of the discontinuity.

FIG. 8 shows the vehicle of FIG. 1 in a seventh posture where the vehicle is traversing a discontinuity in a gradient of a driving surface and where the vehicle has a breakover angle that is larger than a breakover angle in the sixth posture caused by raising a front portion and a rear portion of the vehicle.

FIG. 9 illustrates a schematic of an embodiment of a suspension system interposed between a sprung mass and an unsprung mass of a vehicle.

FIG. 10 illustrates a schematic of a second embodiment of a suspension system interposed between a sprung mass and an unsprung mass of the vehicle.

FIG. 11 illustrates an embodiment of a control system of a suspension system of a vehicle that includes one or more actuators.

### DETAILED DESCRIPTION

In some instances, transitions between driving surfaces may be impassable by vehicles driving in a traditional mode. For example, vehicles exiting a steeply sloped driveway onto a flat road surface may scrape the surface of the road or the driveway during the transition from the driveway onto the road surface. Certain vehicles, for example vehicles with low ground clearance or other geometric features, may have a particularly difficult time transitioning between surfaces. By contrast, other vehicles, e.g., off road vehicles, typically have a geometry designed to allow larger transitions to be made. In this disclosure, systems and methods are disclosed for using one or more suspension system actuators to adjust a posture (e.g., a pitch angle) of a vehicle body in response to information about driving surface anomalies that may interfere with one or more surfaces on the vehicle. In some embodiments, a vehicle's active suspension system may allow the ride height at each wheel to be adjusted individually. Vehicle posture adjustment is helpful in increasing the ability of all vehicles (including low ground clearance and off road vehicles discussed above) to traverse driving surface anomalies without contacting the driving surface except at the vehicle's wheels.

In some embodiments, a vehicle may operate in multiple modes including, for example, a mode where one or more of the actuators are used to optimize comfort, safety and/or drivability during conventional (e.g., city and/or highway) driving by using, for example, a skyhook controller, and a second mode where a posture (e.g., a pitch angle) of the vehicle body is modified to avoid an anticipated interference or collision with portions of a driving surface (e.g., a road surface while entering or leaving steep ramps or driveways, and/or boulders/rock formations which may be climbed over or traversed during off-road driving).

As used herein, the term “pitch angle” refers to an angle between a vehicle body's longitudinal axis and a horizontal plane. As used herein, the term “increasing a pitch angle in a negative direction” refers to raising a front portion of the vehicle body relative to a rear portion of the vehicle body, while “increasing a pitch angle in a positive direction” refers to lowering a front portion of the vehicle body relative to a rear portion of the vehicle body. It is understood that references herein to a posture of a vehicle and a pitch of a vehicle may, based on the context, refer to a posture of the vehicle body and a pitch angle of the vehicle body, respectively. As used herein, the term “suspension system actuator” refers to an actuator which may be controlled to raise and/or lower one or more corners of a vehicle sprung mass (e.g., a vehicle body) relative to an unsprung mass (e.g., a wheel assembly) while the vehicle is moving in a fore/aft direction. Suspension system actuators may include, for example, controllable active suspension actuators, adjustable spring perches, active roll or sway bars, adjustable air springs, etc.

Modifying a posture (e.g., pitch) of a vehicle body may include adjusting various vehicle angles, e.g., approach angles, departure angles, breakover angles, etc. In some embodiments, while the vehicle is moving in a fore/aft direction, one or more suspension system actuators may be used to adjust a ride height at one or more corners of a vehicle to modify one or more vehicle angles.

In a first driving mode, one or more suspension system actuators may be configured to maintain a preselected posture relative to a road or to another driving surface. Control parameters of one or more controllers of such actuators may be selected to satisfy certain safety, drivability, and/or comfort requirements. A range of factors may be considered, including, for example: speed, direction of travel (e.g., turn radius), road surface conditions, etc. For example, one or more actuator controllers may be configured to control an amount of roll as a function of an instantaneous lateral acceleration of the vehicle. Alternatively or additionally, the suspension system (which includes the suspension system actuators), in a first driving mode, may be designed to limit changes in a pitch angle or a rate of change of the pitch angle for a particular rate of acceleration or deceleration.

By contrast, in a second driving mode, operation of one or more suspension system actuators may be modified to avoid interference between a surface of the vehicle body (and/or an object attached to the vehicle body) and a driving surface over which the vehicle is or will be travelling. In some instances, the vehicle may be an autonomous, semi-autonomous, or a driven vehicle and the one or more suspension system actuators may be modified to change a pitch angle or a roll angle.

In some embodiments, a vehicle may be equipped with an active suspension system and/or with other suspension system actuators, that are configured to operate in multiple modes. During a first driving mode, a vehicle's posture may be maintained by mitigating vertical motion relative to a driving surface (e.g., during city and highway driving) and during a second driving mode, the vehicle's posture may be changed by inducing vertical motion to avoid interference with a portion of the driving surface. In both modes, actuators may be utilized to apply appropriate forces to a vehicle body and to one or more wheels to either mitigate undesirable vertical motion or induce desired vertical motion. In the first driving mode, one or more controllers may be used to control the actuators according to, for example, ground hook and/or skyhook-based control algorithms.

In some embodiments, under exceptional operating conditions, such as, for example, during off-roading and/or traversing steep changes in road gradient, appropriate changes may need to be made to the control algorithms necessary to produce a desired vertical clearance between a portion of the vehicle and a road surface. Under these exceptional operating conditions, one or more of the actuators may be used to adjust a vehicle posture by, for example, adjusting a pitch angle and/or a ride height. The vehicle posture may be adjusted to increase a pitch angle, a departure angle, and/or a breakover angle.

In some embodiments, certain key vehicle parameters, one or more of which may typically not be considered during operation in the first driving mode, may need to be emphasized during operation in the second driving mode. As a result, certain suspension system actuator controllers may operate differently in the first driving mode compared to the second driving mode. In some embodiments, in the second driving mode, controllers may be used to control various actuators to avoid interference while ignoring certain constraints that may be in place in the first driving mode to mitigate, for example, changes in vehicle posture as determined by ground hook and/or skyhook algorithms.

In some embodiments, in a second driving mode, additional data may be obtained (e.g., from local or remote data storage) including information, for example, about certain geometric parameters of the vehicle, for example an approach angle, a departure angle, a breakover angle, and/or a wheelbase length. Geometric parameters such as vehicle angles (e.g. vehicle angles such as angle of approach, angle of departure and breakover angle) as a function of vehicle posture may be used to determine whether a driving surface anomaly may be traversed by establishing a certain vehicle posture. One or more actuator controllers may then be used to establish a desired posture for traversing the driving surface anomaly. Data about details of the driving surface anomaly may also be obtained. The details of the driving surface anomaly may include information such as dimensions or orientation of the anomaly (e.g., for identifying a railroad crossing, incline of a transition to a driveway, incline/height of a boulder). Data about the driving surface may be collected from one or more appropriate forward and/or downward looking sensors such as, for example, LIDAR, radar, laser ranging, and/or acoustic ranging. Information about the driving surface and/or certain vehicle parameters, e.g., vehicle geometry, vehicle angles, and actuator range of vertical motion, may also be obtained from a user interface and/or a data storage device.

In some embodiments, operation in the second driving mode may be limited to, for example, certain speed ranges due to for example, safety considerations, comfort, drivability, etc. In the second driving mode, one or more controllers may be configured to drive actuators to a maximum displacement to, for example, avoid an obstruction. With such positioning, a vehicle may become unstable at certain speeds, e.g. highway speed, and speeds between 20 miles per hour and 75 miles per hour. In some embodiments, a vehicle may be precluded from entering the second driving mode to avoid unexpectedly increasing pitch due to, for example, a sensor or another malfunction.

In certain embodiments, when in second mode operation, it may be necessary to consider, for example, how actuators may be utilized to help a vehicle navigate over a surface without getting stuck or causing the vehicle body (e.g., a bottom surface of the chassis or undercarriage, bumpers, add-ons such as an externally mounted spare tire, etc.) to contact (e.g., scrape against, strike, etc.) a surface of the road or driving surface or an obstruction on the road or ground (e.g., a boulder, a rock formation, etc.).

As used herein, the term “approach angle” refers to the maximum supplementary angle (which may be expressed in degrees) between a first plane onto which a vehicle may climb from a second plane (which may be horizontal or at an angle to the horizontal) on which the vehicle is travelling, without interference between a surface on the vehicle and the surface of the first plane. As used herein, the term “departure angle” refers to the maximum supplementary angle (which may be expressed in degrees) of a first plane that the vehicle may descend from onto a second plane on which it is travelling, without interference between a surface on the vehicle and the surface of the first plane. As used herein, the term “breakover angle” is the maximum supplementary angle (which may be expressed in degrees) between a first plane and a second plane that form a convex surface that a vehicle may drive over without any point on either plane touching any surface of the vehicle (other than the wheels).

These angles may be adjusted actively by using one or more suspension system actuators, such as, for example, hydraulic actuators, electrohydraulic actors, electromagnetic actuators, or pneumatic actuators (e.g., air springs). These various actuators may work individually or in cooperation with one or more other actuators (of the same and/or different types) to adjust one or more vehicle angles such as the angle of approach, the angle of departure and/or the breakover angle of a particular vehicle.

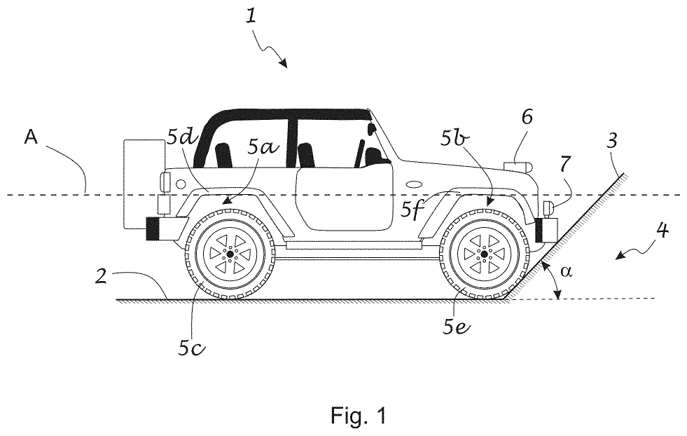

FIG. 1 illustrates a vehicle 1 travelling on a first plane 2 (i.e., at least one front wheel and at least one rear wheel are in contact with the first plane 2) towards a second plane 3. The vehicle 1 in FIG. 1 is positioned in a first posture at least partially defined by longitudinal axis A, the longitudinal axis A being effectively parallel to the first plane 2. The second plane 3 forms a supplementary angle 4 of α degrees with the first plane 2. The first plane 2 may be in a horizontal orientation or at an angle to the horizontal. The angle 4 is equivalent to an angle of approach of the vehicle 1 since it is the maximum transition angle between the first plane 2 and the second plane 3 which the vehicle 1 would be able to traverse without interference between a surface on the vehicle 1 (other than a surface of a wheel) and at least a portion of the second plane 3. A gap 5a, between a top portion of a wheel 5c and a bottom portion of a fender 5d, and a gap 5b, between a top portion of a wheel 5e and a bottom portion of a fender 5f, are indicative of a ride height of the vehicle 1. This spacing (i.e., the size of gaps 5a and 5b) may be controlled by one or more suspension system actuators (not shown) located at each corner of the vehicle 1. A forward-looking sensor 6 and a downward looking sensor 7, may be used to locate and/or characterize various obstructions such as a location and/or an inclination of the second plane 3. It is noted that the first plane 2 and the second plane 3 include driving surfaces upon which the vehicle 1 may travel. In some instances, the driving surface on the first plane 2 and/or the driving surface on the second plane 3 may be a ramp, such as for example, a ramp connecting a road surface to a surface of a trailer bed.

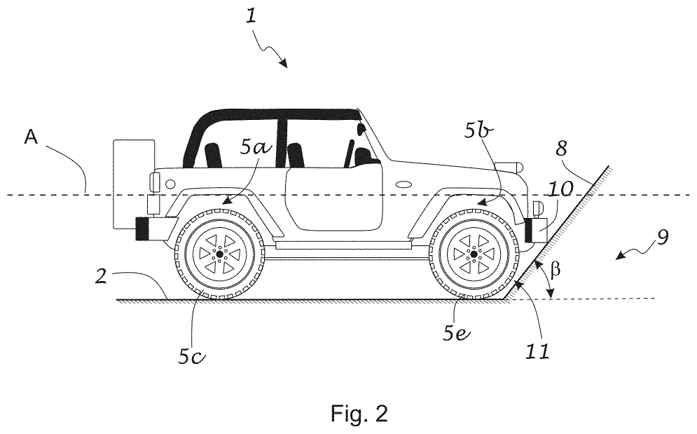

In FIG. 2, the vehicle 1 is in the first posture at least partially defined by longitudinal axis A, which is effectively parallel to the first plane 2, as shown in FIG. 1. The vehicle 1 is positioned on the first plane 2 and approaching a third plane 8. The first plane 2 and the third plane 8 form a supplementary angle 9 of β degrees. The angle 9 of β degrees is greater than the angle 4 of α degrees shown in FIG. 1. As the vehicle 1 has an approach angle of α degrees (as it is in the first posture) and the supplementary angle 9 of β degrees is larger than α degrees, the vehicle 1 is unable to transition onto the third plane 8 without interference. As illustrated in FIG. 2, a bumper 10 of the vehicle 1 reaches the third plane 8 (i.e., there is interference between the bumper 10 and the surface of the third plane 8) which prevents the wheel 5e from moving forward and reaching the third plane 8. A gap 11 between the wheel 5e and the third plane 8 remains. The gap 11 cannot be traversed by wheel 5e to reach the third plane 8 because interference between the bumper 10 and the third plane 8 prevents the vehicle 1 from moving in a forward direction. In this configuration, the vehicle 1 is not able to climb the third plane 8.

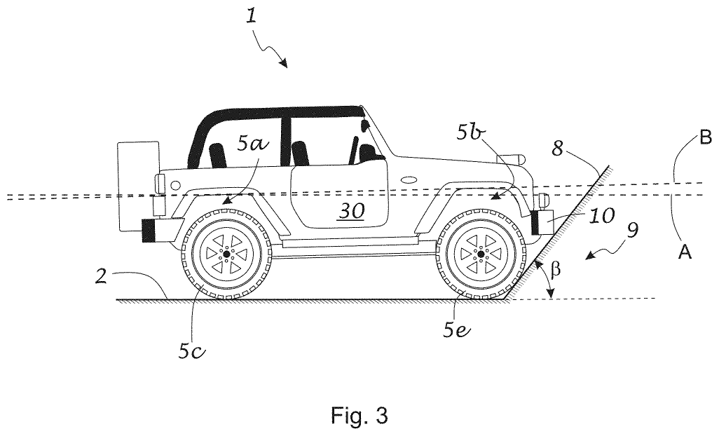

FIG. 3 again shows the first plane 2 and the third plane 8 shown in FIG. 2 but shows the vehicle 1 in a second posture (which is a modified posture as compared to the first posture). In the second posture, the vehicle 1 has a larger pitch angle in a negative direction, as shown by longitudinal axis B, resulting in a larger approach angle for the vehicle 1. This larger pitch angle (and larger approach angle) is created by raising a front portion of the vehicle relative to the first plane 2 (i.e., increasing the gap 5a). In some embodiments, the gap 5a may be increased by using a controller (not shown) to control at least one suspension system actuator operationally interposed between a sprung mass (e.g., a vehicle body 30) and at least one unsprung mass (e.g., the wheel 5e). Accordingly, as illustrated in FIG. 3, the approach angle of the vehicle 1 has been increased to β degrees such that the gap 11 (as shown in FIG. 2) is no longer present when the bumper 10 reaches the third plane 8. In this arrangement, the wheel 5e can reach and climb the third plane 8.

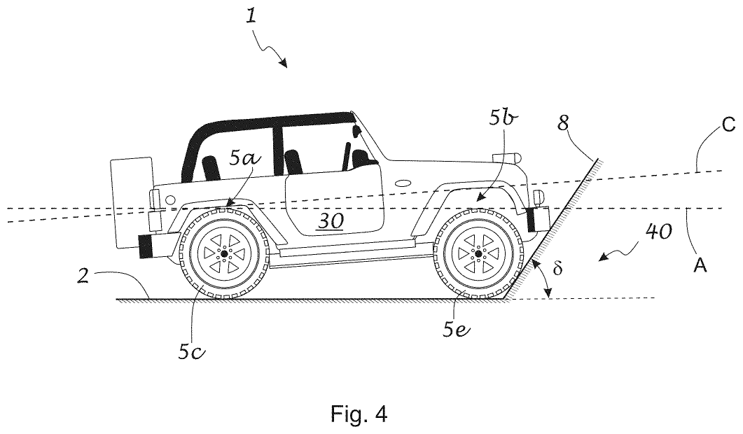

FIG. 4 illustrates the vehicle 1 of FIGS. 1-3 in a third posture. In the third posture, the approach angle of vehicle 1 is increased compared to the first and second postures, as shown by longitudinal axis C. In some embodiments, the approach angle may be increased by a combination of raising the front portion of the vehicle and lowering the back portion of the vehicle, relative to, for example, the first plane 2, by using one or more suspension system actuators at the back portion of the vehicle and one or more suspension system actuators at the front portion of the vehicle. For example, as illustrated in FIG. 4, the front portion of the vehicle may be raised and the rear portion may be lowered resulting in an approach angle of δ for the third posture that is greater than the approach angle β for the second posture illustrated in FIG. 3. As also shown in FIG. 4, a gap 5b may remain the same as in FIG. 3, but the gap 5a may be reduced relative to the corresponding gap of the vehicle shown in FIG. 3. In some embodiments, one or more controllers may be used to concurrently and/or cooperatively operate actuators positioned at the front portion and the rear portion of the vehicle 1 to increase the approach angle by increasing the pitch angle in the negative direction.

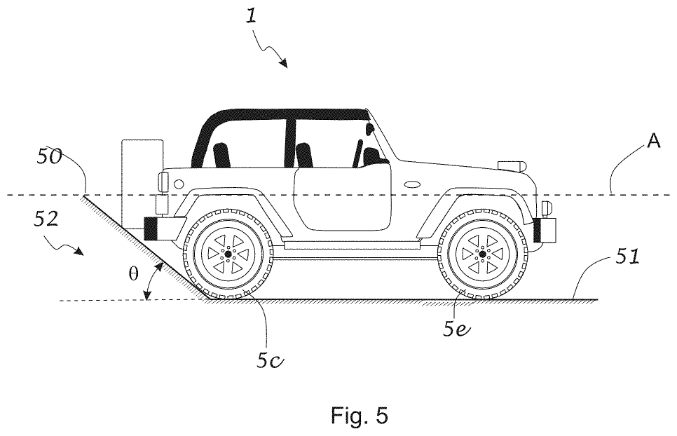

FIG. 5 illustrates the vehicle 1 travelling on a fourth plane 51 (i.e., at least one front wheel and at least one rear wheel are in contact with the fourth plane 51) after traversing a transition from a fifth plane 50. The fifth plane 50, may be, for example, a downward sloping ramp, and the fourth plane 51, may be, for example, a substantially horizontal road surface. The transition between the fourth plane 51 and the fifth plane 50, with a maximum supplementary angle 52 of θ degrees can be traversed by the vehicle 1 (i.e., surfaces of the vehicle 1 and/or surfaces of any objects fixedly attached to the vehicle 1 (e.g., a spare tire, trailer hitch, etc.), besides surfaces on one or more wheels, avoid contacting with the fifth plane 50) if the departure angle of the vehicle is greater than or equal to θ degrees. In this position, the vehicle 1 has a fourth posture (which is the same as the first posture in this instance) where the longitudinal axis A of the vehicle 1 is effectively parallel to the fourth plane 51.

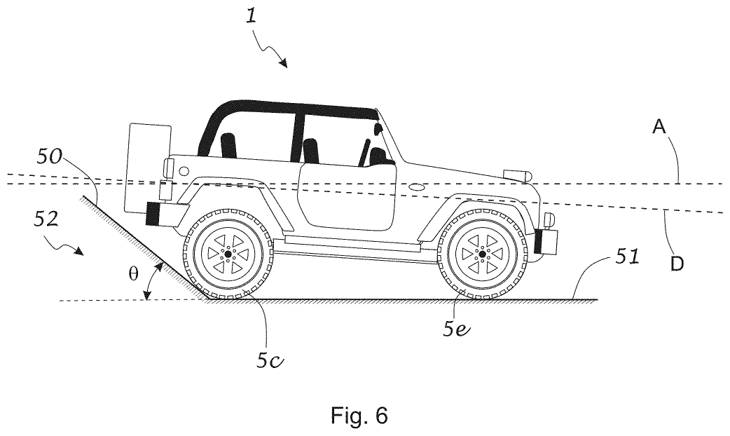

FIG. 6 illustrates vehicle 1 in a fifth posture defined at least partially by longitudinal axis D. In the fifth posture, compared to the fourth posture illustrated in FIG. 5 the vehicle 1 has a larger departure angle (because of the larger the pitch angle in the positive direction). The pitch angle in the fifth posture is created by lowering the front portion of the vehicle 1 and/or raising the rear portion of the vehicle 1 relative to, for example, the fourth plane 51. In some embodiments, one or more controllers may be used to concurrently and/or cooperatively operate actuators positioned at the front portion and the rear portion of the vehicle 1 to increase the departure angle of the vehicle 1 by increasing the pitch angle in the positive direction.

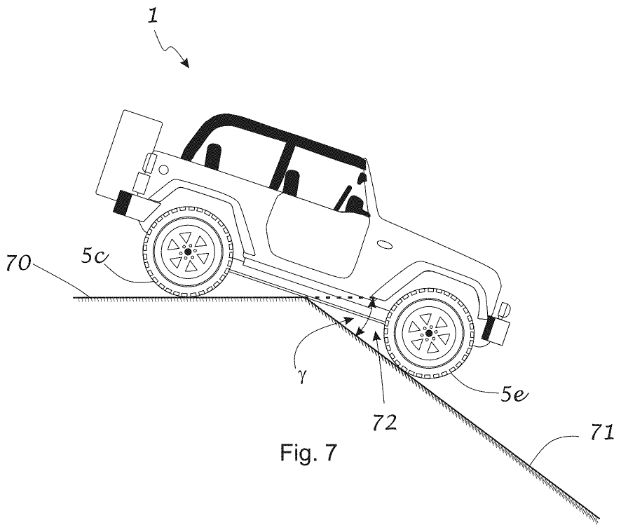

FIG. 7 illustrates the vehicle 1 traversing a transition between a sixth plane 70 and a seventh plane 71 such that at least one front wheel 5e is in contact with the seventh plane 71 and at least one rear wheel 5c is in contact with the sixth plane 70. In the position shown in FIG. 7, the vehicle 1 is in a sixth posture. A breakover angle of the vehicle 1 in the sixth posture is equivalent to the maximum supplementary angle 72 of γ degrees of the angle formed by the sixth plane 70 and the seventh plane 71.

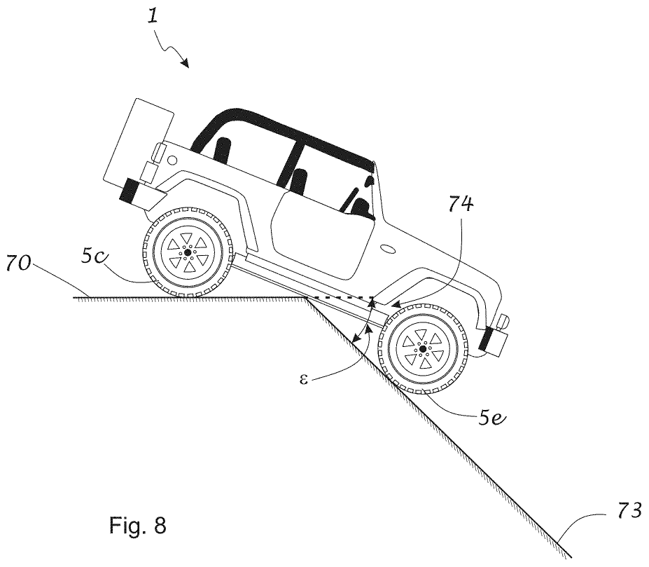

As illustrated in FIG. 8, the vehicle 1 is in a seventh posture where a breakover angle ε of vehicle 1 is larger than the breakover angle γ of the vehicle 1 in the sixth posture as shown in FIG. 7. The breakover angle ε is larger than breakover angle γ because the front portion, the rear portion, or both the front portion and the rear portions of the vehicle 1 have been raised relative to the sixth plane 70 or the seventh plane 71. The front portion and/or the rear portion of the vehicle 1 may be raised by using one or more actuators that are interposed between a sprung mass and at least one unsprung mass of the vehicle 1 at the front portion and/or the rear portion of the vehicle 1. In some implementations, the breakover angle of the vehicle 1 may be increased without altering the pitch angle of the vehicle 1.

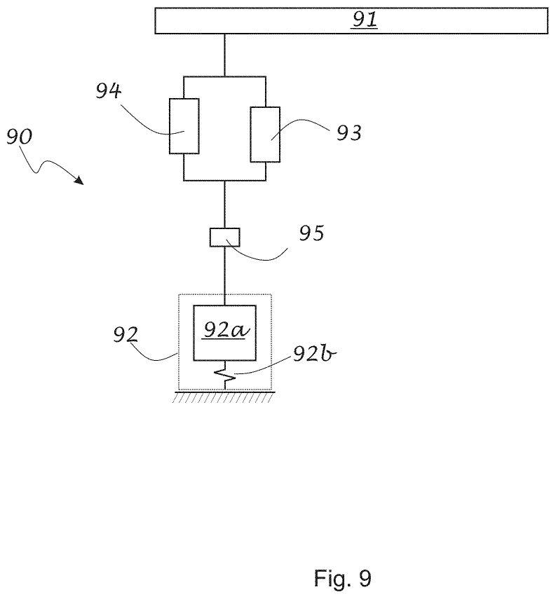

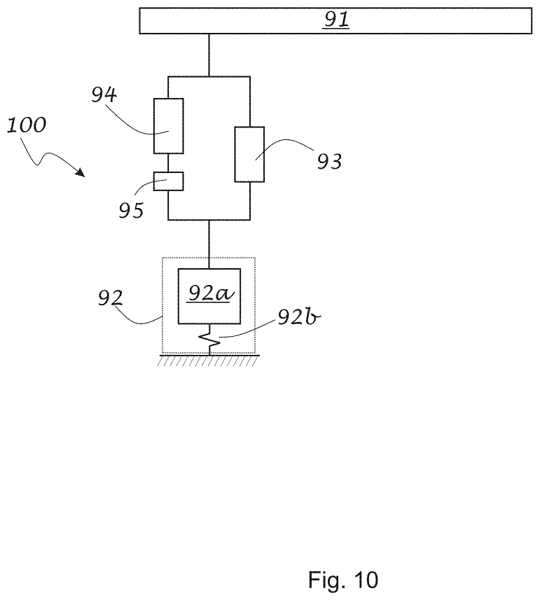

FIG. 9 shows a schematic illustration of a vehicle suspension system 90 interposed between a corner of a sprung mass 91 of a vehicle and an unsprung mass 92 of the vehicle. The unsprung mass 92 includes a mass element 92a and a spring element 92b. The spring element 92b represents a behavior of an air-filled tire which is a part of the unsprung mass 92 which may be a tire. The embodiment shown in FIG. 9 includes an active suspension actuator 93 and a spring element 94 positioned in a parallel arrangement to each other. The suspension actuator 93 may be, for example, a hydraulic actuator, an electro-hydraulic actuator, an electro-mechanical actuator, a linear electric actuator, etc. The spring element 94 may be, for example, a coil spring, a leaf spring, an air spring, etc. The suspension system 90 may also include a spring perch actuator 95 that may interposed between the parallel combination of the actuator 93 and the spring element 94, and the unsprung mass 92 or alternatively (not shown) may be interposed between the parallel combination of the actuator 93 and the spring element 94, and the sprung mass 91. FIG. 10 shows a schematic illustration of a further alternative of a vehicle suspension system 100 interposed between a corner of the sprung mass 91 of a vehicle and an unsprung mass 92. In this embodiment, the spring perch actuator 95 is positioned in series with the spring element 94.

In some embodiments, one or more controllers may be used in a first mode to control one or more actuators, such as for example, active suspension actuators to apply one or more forces to one or more corners of a vehicle sprung mass to mitigate vertical movement of the sprung mass. In some embodiments, a controller may be used to control the one or more actuators by implementing an algorithm that includes a skyhook control strategy. In some embodiments, mitigating the movement of the sprung mass may include mitigating the pitch of the vehicle body, e.g. during braking or accelerating maneuvers, and/or during traversal of non-level driving surfaces. In some embodiments, mitigating the movement of the sprung mass may include mitigating a roll of the vehicle body, e.g. during cornering maneuvers, and/or during traversal of non-level driving surfaces. Disturbances to the pitch and/or roll angle of the vehicle body may be mitigated, for example, by using a controller to implement a skyhook control algorithm in response to, for example, various sensors, such as, for example, accelerometers that measure the vertical component of the acceleration of at least a portion of the sprung mass.

In a second mode of operation, the one or more controllers may be used to control one or more actuators to apply one or more forces to one or more corners of a vehicle sprung mass to induce movement of the sprung mass. In some embodiments, the movement of the vehicle that may be induced, in the second mode, may include modification of the pitch angle of the vehicle. In the second mode, the controller may respond to information from one or more sensors, such as forward-looking sensors (e.g., LIDAR, radar, vision, acoustic, etc.) and/or a user interface that indicates the need for an increase of various vehicle angles (e.g., approach angle, departure angle, and/or breakover angle). In the second mode, alternatively or additionally, the controller may respond to information and/or commands provided by means of a user interface.

In some embodiments, a vehicle controller may prevent the vehicle from operating in the second mode when the one or more operating parameters are within a certain range. For example, in some embodiments, a controller may preclude operation in the second mode if the vehicle speed is between 20 mph and 100 mph. In some embodiments, a controller may preclude operation in the second mode if the vehicle speed is between 10 mph and 100 mph. In some embodiments, a controller may preclude operation in the second mode unless it receives a predetermined signal from a user interface. In some embodiments, changes to the vehicle angles may be at least partially controlled by an operator using a user interface.

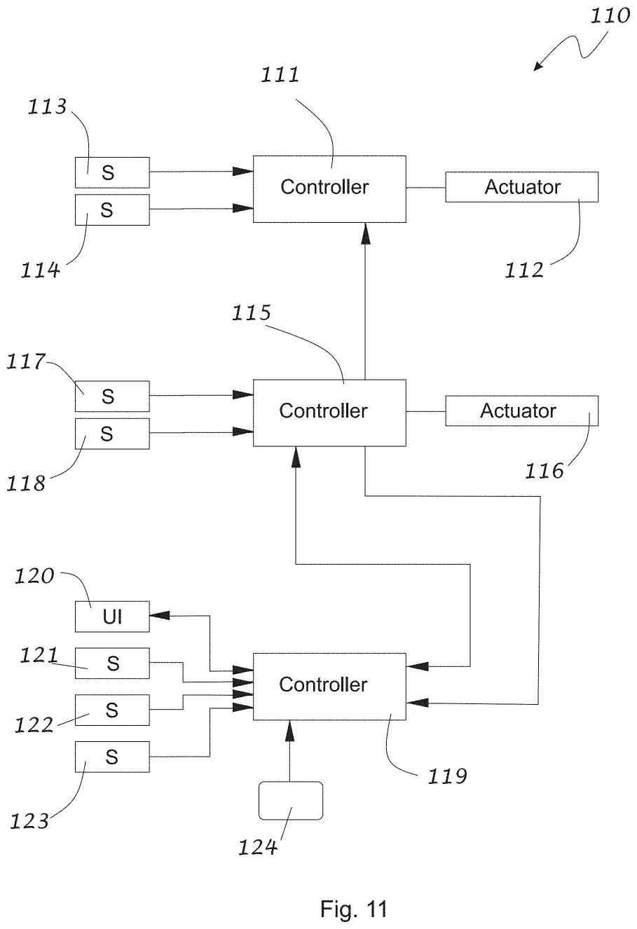

FIG. 11 illustrates an example block diagram of a multi-actuator system 110 that may be used to perform various procedures, such as those discussed herein. The system includes a first dedicated suspension system actuator controller 111 for controlling a first actuator 112, which is operatively disposed between the sprung mass (not shown) and a first unsprung mass (not shown) of a vehicle, based on information from sensors 113 and 114. The actuator 112 may be, for example, an active suspension actuator, an adjustable spring perch actuator, an adjustable air spring, etc. The controller 111 may also control two or more actuators that may be interposed between the sprung mass and the first unsprung mass. A dedicated controller 115 may control actuator 116, which is operatively disposed between the sprung mass and a second unsprung mass (not shown) of the vehicle, based on information from sensors 117 and 118. The dedicated controller 111 may also exchange information with one or more other controllers such as, for example, a central controller 119 and/or a dedicated controller 115.

In some embodiments, the central controller 119 may be combined with the dedicated controller 115 and serve the functions of both. In some embodiments, the central controller 119 may be used to directly control multiple actuators without the need for dedicated controllers.

The dedicated controller 119 may also exchange information with a user interface 120 and receive information from one or more sensors 121, 122, and 123, such as for example, LIDAR, radar, laser range detector, acoustic range detector, etc. The central controller 119 may also exchange information with a storage device 124 which may include information about the geometry or dimensions of the vehicle, digital map data, information about obstructions, and/or rapid transitions in road surface slope including, for example, their locations.

These controllers may work individually or cooperatively to mitigate vertical vehicle motion during a first mode of operation, but to adjust the posture of the vehicle during the second mode to, for example, temporarily increase one or more of the angle of approach, the angle of departure, and the breakover angle. In various embodiments the functions ascribed to a single controller herein may be distributed among a set of controllers.

We claim:

1. A method of operating a first motor vehicle, comprising:
with one or more controllers, receiving information based on data from a first set of one or more sensors;
with the one or more controllers, over a first segment of a driving surface, using at least a portion of the information based on data from the first set of one or more sensors to control a first set of one or more actuators to minimize relative motion between a sprung mass of the first motor vehicle and the first segment of the driving surface;
with the one or more controllers, receiving information based on data from a second set of one or more sensors; and
with the one or more controllers, over a second segment of the driving surface, using at least a portion of the information based on data from the second set of sensors to control a second set of one or more actuators to modify a vehicle angle selected from the group consisting of an approach angle, a departure angle, and a breakover angle,
wherein the first set of actuators and the second set of actuators have at least one actuator in common.

2. The method of claim 1, wherein modifying the vehicle angle comprises increasing a pitch angle in at least one of a positive direction and a negative direction.

3. The method of claim 2, wherein minimizing relative motion between the sprung mass of the first vehicle and the first segment of the driving surface includes using a skyhook control algorithm in at least one of the one or more controllers.

4. The method of claim 2, wherein the first segment of the driving surface is a portion of a road selected from the group consisting of a public city road and a public highway.

5. The method of claim 4, wherein the second segment of the driving surface is a portion of an off-road surface.

6. The method of claim 1, wherein the at least one actuator in common is selected from the group consisting of an active suspension actuator, an adjustable air spring, and an active roll bar.

7. The method of claim 1, wherein the information based on data received from at least one of the first set of one or more sensors and the second set of one or more sensors includes information about the location of the first vehicle relative to the driving surface.

8. The method of claim 1, wherein the first set of sensors and the second set of sensors have at least one sensor in common.

9. The method of claim 8, wherein the at least one sensor in common is selected from the group consisting of a LIDAR system, a radar system, and a GPS receiver.

10. The method of claim 7, further comprising providing, to a second vehicle or a central data storage facility, information about a modification of the vehicle angle and the location where the modification was made.

11. The method of claim 1, wherein modifying the vehicle angle comprises adjusting a ride height of the first vehicle while maintaining a pitch angle of the vehicle.

12. A method of operating a motor vehicle that includes at least a first suspension system actuator, the method comprising:
obtaining information about a first motion of a sprung mass of the motor vehicle;
operating a first controller configured to execute a first control algorithm that generates a first command signal based on the information about the first motion;
providing the first command signal to the first suspension system actuator;
generating a first force with the first suspension system actuator;
applying the first force to the sprung mass to mitigate the first motion;
obtaining information about a driving surface to be traversed by the motor vehicle;
obtaining information about the geometry of the motor vehicle;
based at least on the information about the driving surface and the information about the geometry of the motor vehicle, determining that a segment on the driving surface will interfere with a surface on the motor vehicle;
operating a second controller that includes a second control algorithm configured to execute a second command signal based on the information about the driving surface and the information about the geometry of the motor vehicle;
providing the second command signal to the first suspension system actuator;
generating a second force with the first suspension system actuator; and
applying the second force to the sprung mass to induce a second motion.

13. The method of claim 12, wherein the first motion and the second motion include changes in a pitch angle of the vehicle.

14. The method of claim 13, wherein the first motion occurs during fore-aft acceleration or deceleration of the vehicle, and wherein the second motion is induced to avoid interference between the surface on the vehicle and the segment on the driving surface.

15. The method of claim 12, wherein the first controller and the second controller are the same controller.

16. A method of operating a suspension system of a vehicle having one or more front wheels, one or more rear wheels, and a vehicle body, the method comprising:
obtaining information about a terrain ahead of the vehicle;
based on the obtained information, determining that a slope of the terrain exceeds an approach angle of the vehicle;
in response to said determination, compressing at least one actuator arranged between a rear wheel and the vehicle body and extending at least one actuator arranged between a front wheel and the vehicle body, thereby increasing a pitch of the vehicle body to increase the approach angle.

17. A method of operating a suspension system of a vehicle having one or more front wheels, one or more rear wheels, and a vehicle body, the method comprising
operating at least a controller in a first operating mode to use at least one active suspension actuator to mitigate a motion of the vehicle body while the vehicle is being driven;
operating the at least one controller in a second operating mode to use the at one active suspension actuator to increase a vehicle angle selected from the group consisting of an approach angle and a departure angle.

18. The method of claim 17, wherein in the first operating mode the controller uses a motion mitigation control strategy selected from the group consisting of a ground hook algorithm and a skyhook algorithm.

19. The method of claim 17, wherein in the second operating mode the approach angle is increased by raising the front of the vehicle and lowering the rear of the vehicle while the vehicle is being driven.

20. The method of claim 17, wherein in the second operating mode the departure angle is increased by raising the rear of the vehicle and lowering the front of the vehicle while the vehicle is being driven.
